(19) United States
(12) Patent Application Publication
(10) Pub. No.: US 2020/0370964 A1
(43) Pub. Date: Nov. 26, 2020

(54) METHOD AND APPARATUS FOR MEASURING A CURVED WAVEFRONT USING AT LEAST ONE WAVEFRONT SENSOR

(71) Applicant: MICRO-EPSILON OPTRONIC GMBH, Langebruck (DE)

(72) Inventors: Georg Schitter, Vienna (AT); Markus Thier, Vienna (AT); Rene Paris, Vienna (AT); Severin Unger, Munich (DE); Han Woong Yoo, Vienna (AT)

(21) Appl. No.: 16/311,615

(22) PCT Filed: Apr. 20, 2017
(86) PCT No.: PCT/DE2017/200035

§ 371 Date: Jul. 9, 2020

(30) Foreign Application Priority Data
Jun. 20, 2016 (DE) 10 2016 210 966.9

(51) Int. Cl. G01J 9/00

(52) U.S. Cl. CPC G01J 9/00; G01J 2009/002

(57) ABSTRACT

With regard to a particularly precise measurement of a wavefront using structurally simple means, a method for measuring a curved wavefront using a wavefront sensor is specified, wherein a plurality of measurements are carried out at different positions along the wavefront using at least one wavefront sensor in order to determine a local gradient of the wavefront at the different positions, which method is characterized in that the plurality of measurements are carried out in each case with a substantially tangential alignment of a light entrance plane of the wavefront sensor(s) with the curved wavefront. A corresponding apparatus for measuring a curved wavefront using a wavefront sensor is also specified.

With regard to a particularly precise measurement of a wavefront using structurally simple means, a method for measuring a curved wavefront using a wavefront sensor is specified, wherein a plurality of measurements are carried out at different positions along the wavefront using at least one wavefront sensor in order to determine a local gradient of the wavefront at the different positions, which method is characterized in that the plurality of measurements are carried out in each case with a substantially tangential alignment of a light entrance plane of the wavefront sensor(s) with the curved wavefront. A corresponding apparatus for measuring a curved wavefront using a wavefront sensor is also specified.

The invention relates to a method and to an apparatus for measuring a curved wavefront using at least one wavefront sensor, wherein a plurality of measurements are carried out at different positions along the wavefront using at least one wavefront sensor in order to determine a local gradient of the wavefront at the different positions.

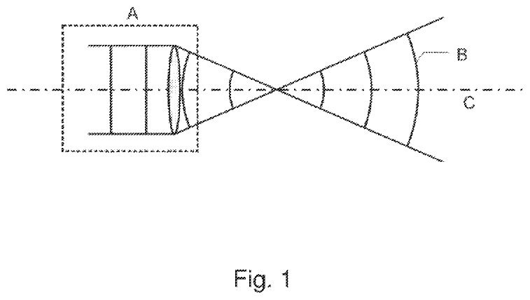

Methods and apparatuses of the type mentioned at the start are known in practice and exist in different embodiments. Here, a precise measurement of strongly curved wavefronts is often desirable. In order to explain such a measurement, a spherical wavefront is considered below, as a representative example of a curved wavefront, is generated by a test optical system such as a lens, for example. For this purpose, in FIG. 1, a typical course of a light beam is represented diagrammatically. Here, a test optical system A generates a spherical wavefront B along an optical axis C. Here, the propagation direction in FIG. 1 is from left to right.

A planar wavefront incident on the test optical system A, which is generated for example by a coherent light source such as a laser, for example, is focused by the test optical system A, whereby spherical wavefronts B are generated. A wavefront B generated in the process can be considered in reference to an ideal spherical wavefront, so that a qualitative statement regarding the test optical system A can be made. The measurement of the wavefront A is carried out via so-called wavefront sensors.

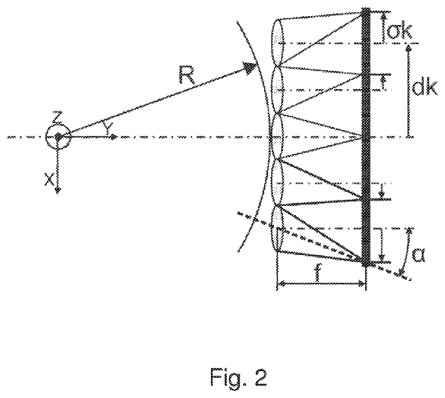

Based on a simple and robust underlying measurement principle, wavefront sensors today are commonly designed according to the Shack-Hartmann principle for measuring a local wavefront curvature. In FIG. 2, such a wavefront sensor is represented diagrammatically, wherein a spherical wavefront is locally scanned via a microlens array of the wavefront sensor. A local inclination of the wavefront here brings about a displacement σₖ of the focal points relative to the optical axis of the microlens. In other words, a local inclination of the wavefront is represented in a displacement σₖ of the associated focal point. The wavefront has a radius R. Distances from the optical axis are designated dₖ. Moreover, the angle of incidence of the wavefront on the microlens is marked α. The focal length of the microlenses is f.

The displacements σₖ of the focal points on a 2D detector, for example, an image sensor, are directly proportional to the local gradients of the wavefront which, via integration methods, enable the spatial reconstruction of the entire wavefront.

A relation between the radius R of a spherical wavefront, the distances dₖ from the optical axis, and the local displacements σₖ can be established as follows:

$${σ}_{k} = \frac{{d}_{k} f}{R}$$

The occurring local gradient tan(α) of the wavefront can be expressed via the focal length f of a microlens as follows:

$$tan ( α ) = \frac{{σ}_{k}}{f}$$

To implement a precise measurement of the spherical wavefront, the goal is to limit the maximally occurring gradient tan(αₘₐₓ), since, with increasing angle α, the comatic aberration which is determined by the manufacturing quality of the microlens increases and distorts the measurement.

In order to limit the gradient of the wavefront, the following approaches are conceivable:

1. The distance R can be increased. In addition to decreasing the wavefront gradient tan(αₘₐₓ), this approach leads at the same time to a higher local scanning density. However, thereby, on the one hand, the area of the wavefront to be measured may become larger than the aperture—measurement area—of the sensor, and, on the other hand, the intensity may decrease.

2. The focal length of the microlenses can be decreased.

The mentioned approaches can naturally also be combined.

With a view to the first approach, a method for measuring a curved wavefront is known from EP 1 192 433 B1. According to the known method, a wavefront sensor is moved by translation over the surface of the wavefront to be measured. Thereby, a wavefront can be measured which is larger than the aperture of the sensor. The entire wavefront is assembled by so-called “stitching” from the measured sub-areas. Corresponding stitching methods are known from the prior art

On this topic, reference is made to the publication H. Li, G. Feng, J. Sun, T. Bourgade, S. Zhou and A. Asundi, “wavefront subaperture stitching with Shack-Hartmann sensor,” 2015, wherein a measurement of a strongly curved spherical wavefront using a Shack-Hartmann sensor is described, wherein the spatial position of the sensor is changed repeatedly in order to acquire the entire wavefront. Moreover, in the publication, the mathematical procedures are described for assembling several sub-areas of the wavefront measured spatially offset in order to form a single wavefront, wherein the measured sub-areas spatially overlap. Here, for the overlap area of two sub-areas in each case, the fact that the two measured wavefronts are inclined relative to one another is taken into account.

For further technological background, reference is also made to US 2008/0018910 A1 and DE 10 2013 002 007 A1, wherein, according to the publications, systems and methods for measuring and imaging three-dimensional structures, and methods and apparatuses for receiving and processing the optical signals originating from an extended object are described.

The underlying aim of the present invention is to specify a method and an apparatus for measuring a curved wavefront using a wavefront sensor, according to which a particularly precise measurement of the wavefront is made possible using structurally simple means.

According to the invention, the above aim is achieved by a method having the features of claim 1. Accordingly, the method is characterized in that a plurality of measurements are carried out in each case with substantially tangential alignment of a light entrance plane of the wavefront sensor(s) with the curved wavefront.

Moreover, the above aim is achieved by an apparatus having the features of claim 18. Accordingly, the apparatus is designed and developed in such a manner that the wavefront sensor(s) can he positioned for carrying out the plurality of measurements in each case with substantially tangential alignment of a light entrance plane of the wavefront sensor(s) with the curved wavefront.

According to the invention, it has been found that, by means of a skillful alignment of one or more wavefront sensors during the measurements, the above aim is achieved surprisingly simply. For this purpose, an alignment of the wavefront sensor(s) is selected, in which a light entrance plane of the wavefront sensor(s) is made to be substantially tangential to the curved wavefront. Ultimately, the wavefront sensors are here aligned for each measurement as optimally as possible with respect to the wavefront to be measured. Thereby, a maximally occurring gradient of the wavefront is kept as small as possible for each measurement. In other words, the wavefront sensor(s) is/are adjusted during a measurement to the curvature of a wavefront to be measured or aligned therewith. Here, the wavefront sensor(s) is/are aligned or inclined as optimally as possible with respect to the wavefront for each individual measurement. Finally, from the plurality of measurements, the entire wavefront can be reconstructed.

Consequently, by the method according to the invention and the apparatus according to the invention, a method and an apparatus are specified whereby a particularly precise measurement of the wavefront is made possible using structurally simple means.

With a view to a particularly simple implementation of the method, the at least one wavefront sensor can be a Shack-Hartmann sensor. Such sensors are characterized by a simple and robust measurement principle.

In a concrete embodiment of the method, the Shack-Hartmann sensor or wavefront sensor can be aligned at the different positions in such a manner that a function f(σ₁, σ₂, . . . , σ_{N}), which is dependent on at least one displacement σₖ from a focal point to a reference point of a microlens of the Shack-Hartmann sensor or wavefront sensor, is minimized, wherein the displacement σₖ of the associated focal point corresponds to an imaging of the local inclination of the wavefront by means of the respective microlens, In reference to FIG. 2 and the measurement principle explained therein, in the case of a Shack-Hartmann sensor, it must be kept in mind that the wavefront to be measured is focused by N lenses on N points on the detector plane. For each of these points, the displacement σₖ with respect to a reference point can be calculated. The respective wavefront sensor can here be aligned in such a manner that, for the wavefront sensor, practically any desired displacement function f(σ₁, σ₂, . . . , σ_{N}) is minimized. From this a rule a particularly precise measurement of the wavefront results.

Concretely, the function f(σ₁, σ₂, . . . , σ_{N}) can represent the weighted average of all the displacements σₖ or the weighted average of the squares of all the displacements σₖ. In particular, this also covers the case in which the function f weights only a single displacement σ_{E}, and all the other displacements σₖ, k≠E, are weighted with the factor 0.

Very generally, the alignment of one or more wavefront sensors can advantageously be carried out in such a manner that the displacement(s) σₖ is/are as small as possible or below a predeterminable threshold value. Thereby, the end effect achieved is a particularly precise measurement of the wavefront, while avoiding or largely minimizing all aberrations.

Depending on the necessary precision for the measurement of the wavefront, the alignment of one or more wavefront sensors can be carried out in each case before a measurement and/or between two or more measurements. This can involve in particular measurements of the wavefront which are carried out for the purpose of reconstructing a single wavefront from these measurements. Thus the plurality of measurements can be measurements of one wavefront to be measured.

In an additional advantageous design, the alignment of one or more wavefront sensors can be carried out continuously during a movement of one or more wavefront sensors. Such a continuous alignment can be carried out in particular when a wavefront area which is larger than the apertures) of the wavefront sensor(s) is to be acquired.

With regard to a largest possible covering of an area of a wavefront, the wavefront sensor(s ca be moved along one or more substantially circular trajectories in order to reach the different positions. Thereby, a reliable sensing of the area of the wavefront to be measured can be achieved.

With a view to a particularly high precision of the measurement, the measurements can be carried out with at least partial overlap along the wavefront. Here, at least sub-areas of the wavefront to be measured are measured repeatedly.

With a view to a particularly simple and reliable alignment of the wavefront sensors, the wavefront sensor(s) can be pivotable around one axis or around two different axes. In the case of the implementation of two such axes, the axes can preferably be oriented at a right angle with respect to one another and/or preferably intersect.

In an additional advantageous design, the wavefront sensor(s) can be aligned via a controller of a control circuit in such a manner that a focal point of the wavefront, generated by means of a lens of a wavefront sensor, lies on an optical axis or on the optical axis of the lens, wherein, preferably, the local gradient of the wavefront is derived from the alignment of the control signals generated for the alignment of the wavefront sensor(s). Here, the controller can align the wavefront sensor at each different position in such a manner that the focal point lies on the optical axis. Such control is available in particular for the case in which the sensor consists of a single lens with detector.

In an additional advantageous embodiment, an optical system generating the wavefront can be rotated or be rotatable around an optical axis for the relative positioning of the wavefront with respect to the wavefront sensor(s). Here, by rotating the optical system which generates the wavefront, the wavefront to be measured is rotated practically around the rotation axis of the optical system. In a corresponding manner, for the sensing of a selected area of the wavefront, in this case just a translational mobility of the wavefront sensor(s) with a corresponding tangential allignability is sufficient.

In the context of an additional embodiment, one or more wavefront sensors suspended at a suspension point can be set in oscillating motion around the suspension point in order to reach the different positions. By the oscillating motion, the scanning of a selected area of the wavefront to be measured is made possible.

With a view to a particularly simple and rapid measurement of the wavefront, a plurality of wavefront sensors can be arranged on a carrier, wherein the wavefront sensors can preferably be tilted relative to the carrier around at least one axis and preferably be shifted relative to the carrier. Here, using a simultaneous measurement by means of a plurality of wavefront sensors arranged on the carrier, a plurality of measurements can be carried out at the same time at different positions along the wavefront. In this case, the wavefront can be reconstructed based on the measurement data of the individual wavefront sensors. Here too, an alignment of the wavefront sensors can be carried out in each case before a measurement and/or between two or more measurements. With such a carrier, when the carrier is moved, a movement of all the wavefront sensors arranged on the carrier necessarily occurs at the same time.

In an additional advantageous embodiment, an end of an optical waveguide can scan the wavefront at least in sections, wherein light received at the different positions is transmitted by means of the optical waveguide to the light entrance plane of the wavefront sensor(s). Here, the optical waveguide can be set in scanning motion, preferably along a circular track, by means of a movement device. The scanning of the wavefront or the movement of the end of the optical waveguide usually takes place in the converging beam path of a focusing optical system.

In an advantageous design, the wavefront can be reflected by at least one mirror onto the wavefront sensor(s), wherein the mirror can be pivoted around one axis or around two axes for the measurement at the different positions. Here, a wavefront of a focusing optical system is reflected by one or more mirrors onto the wavefront sensor(s). The wavefront sensor(s) can here he stationary. It is important here that the focal point generated by the focusing optical system lies in a respective mirror plane.

In embodiment examples of the present invention, in principle, an adjustment of the orientation of one or more wavefront sensors with respect to the wavefront to be measured is carried out at the respective position of the wavefront sensor. Here, the light entrance opening of the wavefront sensor or the light entrance plane is assumed to be an ideal plane. This ideal plane can be oriented tangentially with respect to a virtual reference surface, wherein the center point of the ideal plane contacts the virtual reference surface. The virtual reference surface here is selected as desired and adjusted to the respective application.

The method according to the invention and the apparatus according to the invention can be used advantageously in particular with strongly curved wavefronts. Possibly, but not necessarily, such wavefronts are greatly extended spatially, so that a plurality of measurements are necessary at different spatial positions in order to be able to acquire the entire wavefront by metrologically, and/or a plurality of measurements with different orientations with respect to the wavefront are necessary so as to stay within the dynamic range of the respective wavefront sensor for different areas of the wavefront.

According to the method according to the invention, during the measurement, a practically optimal relation between the dynamic range of the wavefront sensor and the precision of the measurement can be achieved. For this purpose, the displacements σₖ should be kept as small as possible. In particular, wavefront gradients can also be acquired thereby, which, without relative alignment, would exceed the dynamic range of the sensor.

Different possibilities then exist for advantageously designing and developing the teaching of the present invention. For this purpose, on the one hand, reference is made to the claims below and, on the other hand, to the following explanation of preferred embodiment examples of the invention in reference to the drawing. In connection with the explanation of the preferred embodiment examples of the invention in reference to the drawing, preferred designs and developments of the teaching are also explained in general. In the drawing,

FIG. 1 in a diagrammatic representation, shows a typical situation for a measurement of a curved wavefront,

FIG. 2 in a diagrammatic representation, shows a measurement of a wavefront according to the Shack-Hartmann principle,

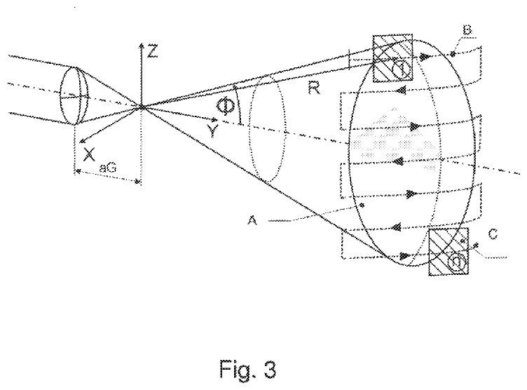

FIG. 3 in a diagrammatic representation, shows an embodiment example of a method according to the invention for measuring a curved wavefront,

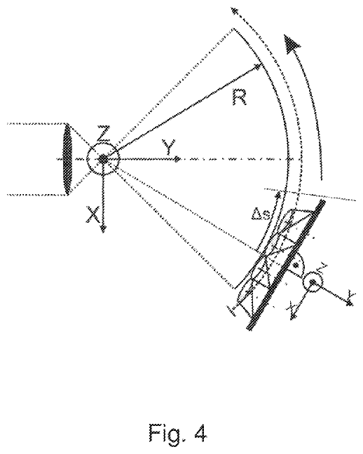

FIG. 4 in a diagrammatic representation, shows a tangential alignment of a wavefront sensor with respect to a wavefront,

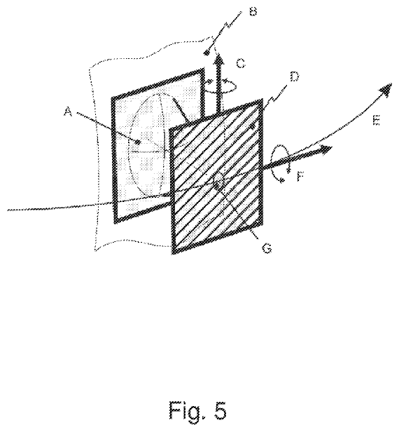

FIG. 5 in a diagrammatic representation, shows an additional embodiment example of a method according to the invention, wherein the wavefront sensor consists of a single lens with detector,

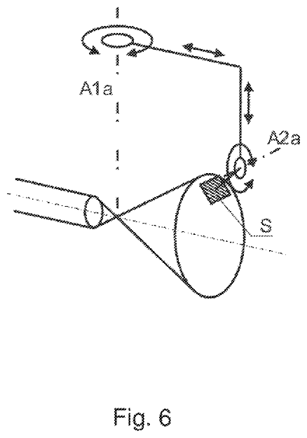

FIG. 6 in a diagrammatic representation, shows an embodiment example of a method according to he invention with a stationary test optical system and a wavefront sensor which can be pivoted around two axes and shifted in two directions,

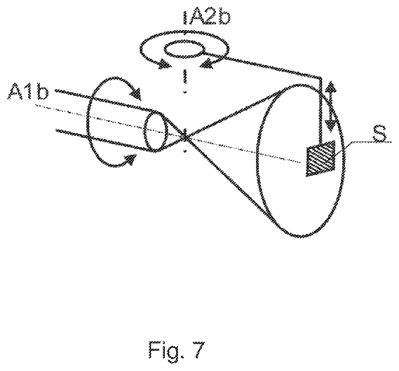

FIG. 7 in a diagrammatic representation, shows an additional embodiment example of a method according to the invention with a test optical system which can be rotated around an optical axis and with a wavefront sensor which can be pivoted around an axis,

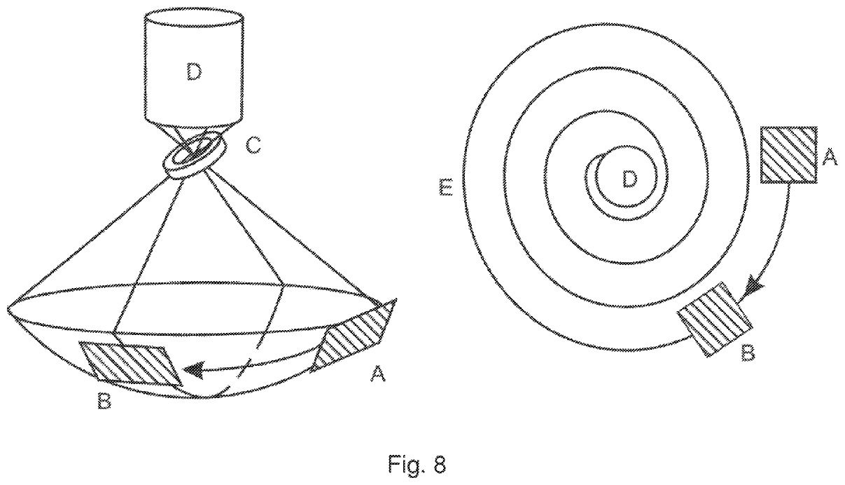

FIG. 8 in a diagrammatic representation, shows an additional embodiment example of a method according to the invention with a wavefront sensor suspended as a pendulum, in a side view and in a top view,

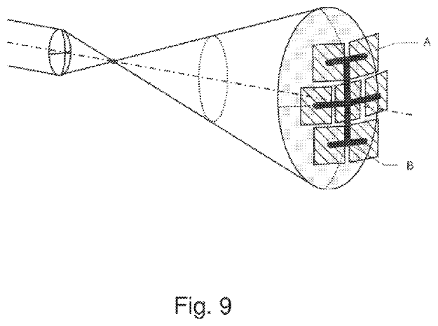

FIG. 9 in a diagrammatic representation, shows an additional embodiment example of a method according to the invention with an array of wavefront sensors arranged on a carrier,

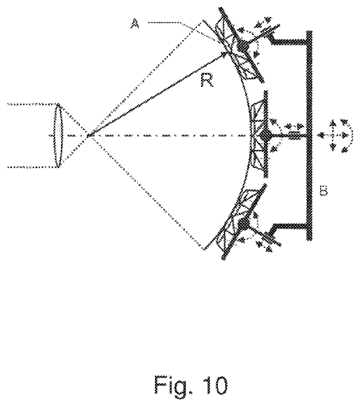

FIG. 10 in a diagrammatic representation, shows the tiltability and shiftability of wavefront sensors arranged on a carrier according to FIG. 9,

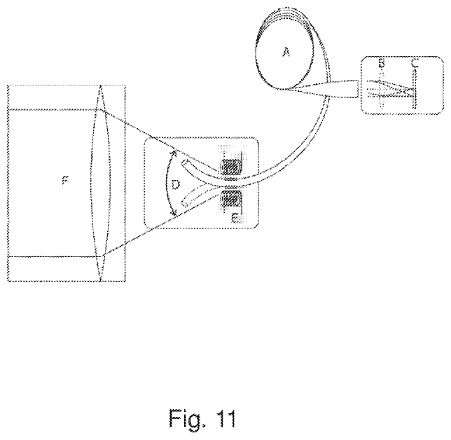

FIG. 11 in a diagrammatic representation, shows an additional embodiment example of a method according to the invention with a movable optical waveguide for sensing the wavefront,

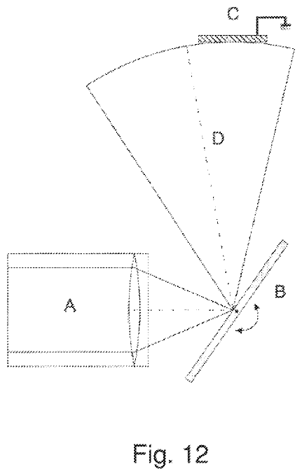

FIG. 12 in a diagrammatic representation, shows an additional embodiment example of a method according to the invention with a deflection mirror for the reflection of the wavefront onto a stationary wavefront sensor, and

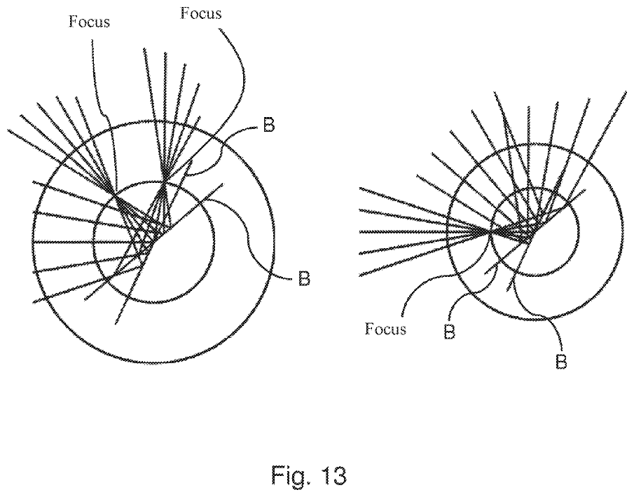

FIG. 13 shows an arrangement of a deflection mirror, wherein the focus of a converging light beam lies preferably on the mirror surface.

FIGS. 3 and 4 show, in diagrammatic representations, an embodiment example of the method according to the invention for measuring a curved wavefront A, wherein a Shack-Hartmann sensor is used as wavefront sensor, and a spherical wavefront A is measured. For the delimitation of the maximum local gradient tan(αₘₐₓ) of the wavefront A, the entire spherical wavefront A is scanned at a certain distance R along a circular trajectory B at specific points 1 to n. Here, the course of the scanning trajectory Bis represented by a dotted line. Ultimately, a predetermined area of the wavefront A is sensed by individual measurements which are represented by crosshatched areas C. All the individual measurements are recorded along the scanning trajectory B. The area C corresponds to the acquired area of the individual wavefront sensor at a point in time.

FIG. 4 shows the tangential alignment of the wavefront sensor with respect to the wavefront A. The individual positions or measurement points can be selected so that the individual wavefront images overlap. The entire wavefront is assembled from the sum of the individual wavefronts 1 to n, see FIG. 3. The assembly of the wavefront is carried out by so-called wavefront stitching. The shift displacement ΔS in FIG. 4 here determines the overlap area, by which the precision of the measurement can be influenced. The individual measurements are subsequently imaged on a spherical surface using an algorithm.

Based on a maximum acceptable local gradient tan(αₘₐₓ) of the wavefront, the following equation must be satisfied:

$$tan ( {α}_{max} ) \geq \frac{{d}_{k}}{R}$$

In the case of a maximum acceptable wavefront gradient, it is possible to derive therefrom the necessary distance R, the associated wavefront area, and the number of measurements necessary for a complete wavefront image.

FIG. 5 shows an additional embodiment example in a diagrammatic representation, wherein this relates to a special case in which the sensor consists of a single lens with detector. For this purpose, a commercial lens array can naturally also be used, in which all the other lenses except one are ignored. This sensor is guided along a predetermined scanning trajectory E and is additionally mounted so that it can rotate around two directions—rotation axes C and F. During the measurement process, the inclination of the sensor is controlled via a control circuit so that the focal point lies along the optical axis which corresponds to the detector center. The control signals generated here by the controller of the control circuit for the alignment of the sensor give information on the inclination of the compensated wavefront gradient. Concretely, the wavefront sensor is designed as a 2D detector D which is mounted so that it can rotate around two axes along a scanning trajectory E. During the movement through the scanning trajectory E, the controller attempts to keep the focal point G in the center of the detector D. The control variables generated in the process are proportional to the wavefront gradient. A designates the lens and B designates a wavefront section.

FIG. 6 shows an additional embodiment example of the invention in a diagrammatic representation. Here, the position of a test optical system is fixed, and a wavefront sensor is moved along a circular track by pivoting around an axis A1a. in addition, degrees of translation freedom are provided parallel to the optical axis and parallel to the axis A1a. Depending on the position of the circular track, the sensor is pivoted around an additional axis A2a, in order to be oriented tangentially with respect to the wavefront. The area acquired at a point in time by the wavefront sensor is designated S.

Alternatively, it is also conceivable to use only two degrees of rotational freedom, wherein the associated rotation axes intersect. An additional variant of this embodiment is described in FIG. 7.

FIG. 7 shows an embodiment example of the invention in which the test optical system is mounted so that it can rotate around an axis A1b. By an additional pivotability of the wavefront sensor S around an axis A2b, the complete wavefront can be scanned. Both the axis A2b according to FIG. 7 and the axis A1a according to FIG. 6 run through a focus of the wavefront, which is generated by the test optical system. The tangential alignment with respect to a spherical wavefront is given by the twofold rotatability of the sensor S according to FIG. 7. In addition, the sensor S according to FIG. 7 can also be moved by translation.

FIG. 8 shows an additional embodiment example of the invention in a diagrammatic representation. Here, the wavefront sensor is suspended on a pendulum. Before the measurement, the pendulum with sensor is deflected, and a starting impulse is transmitted. During the deflection process, images of the wavefront are recorded. An additional possibility consists of the actuation of the pendulum at the suspension point in order to set the pendulum in motion. In FIG. 8, the wavefront sensor is represented at two positions A and B, wherein it continues to move substantially in the shape of a spiral during its deflection process from position A to position B. The sensor is suspended on a cardan joint C which is coupled to the test optical system D. The scanning trajectory of the sensor is designated E.

In FIGS. 9 and 10, an additional embodiment example of the invention is represented, wherein a plurality of wavefront sensors A are here attached to a carrier B. Thereby, instead of a single wavefront sensor, a sensor array is formed, which consists of an arrangement of a plurality of wavefront sensors A. The individual sensors A are connected via the carrier B which is used as connection frame or support framework.

For optimal adjustment to the wavefront to be measured, the individual wavefront sensors A can be mounted on their suspension points on the carrier B in in such a manner that they can substantially be freely positioned—rotated and shifted—and adjusted by means of actuators, see FIG. 10. The entire sensor array can be guided for enlarging the measurement range over a predefined scanning trajectory or—while remaining in the position—they can take an instantaneous picture of the wavefront. In the latter case, one does without a gap-free acquisition. According to FIG. 10, the individual wavefront sensors A are connected to one another in a tiltable and shiftable manner via a support framework B, so that any wavefront radii R can be measured.

FIG. 11 shows an additional embodiment example of the invention in a diagrammatic representation. Here, an optical waveguide A is arranged practically as a transmission medium between a wavefront generated by a test optical system F and a detector C. The optical waveguide A is set in oscillation via spatially arranged actuators E, for example voice coil actuators, in such a manner that the start of the optical waveguide A is curved along a circular track or scanning trajectory D. The optical waveguide A sweeps the incident wavefront in a converging area of the light and transfer a segment of the wavefront to an outlet of the optical waveguide A. The outlet is here connected stationarily to a base. At the outlet, a wavefront sensor is arranged. In the case of a Shack-Hartmann sensor, an optical system with a lens B is located at the outlet, which converts the inclination of the wavefront into a displacement of the focal point. In summary, by actuation of the start of the optical waveguide A, the entire wavefront generated by the test optical system F can be sensed, therein in each case a segment of the wavefront is transmitted to the outlet, and an inclination of the wavefront is imaged via a lens system B in a displacement of the focal point. The detector C works according to the Shack-Hartmann principle.

FIG. 12 shows an additional embodiment example of the invention in a diagrammatic representation. Here, the wavefront generated by means of a test optical system A is projected by a deflection mirror B onto a stationary wavefront sensor C. In order to make the principle understandable, only an inclinability of the pivotable mirror B around one axis is represented in FIG. 12. The inclination around a second axis, which is preferably orthogonal with respect to the drawn-in axis, can be implemented in the context of an additional embodiment example. By actuation of the mirror B, the entire wavefront is pivoted over the area of the wavefront sensor C and sensed spatially. Here it is important that the focal point always lies on the mirror surface, since otherwise a movement of the pivot axis is superposed on the pivoting. In the embodiment example shown here, the optical axis D is effectively quasi deflected by means of the deflection mirror B. The wavefront sensor C is represented by the crosshatched area in FIG. 12 and is fixed at a measurement position. Preferably, two orthogonally arranged scanners or deflection mirrors B reflect the incident wavefront in the direction of the wavefront sensor C. By the movement of the scanners or deflection mirrors B, the wavefront to be measured is guided over the measurement area of the sensor C.

In a wavefront analysis, the representation of the measured wavefront is often carried out by superposition of individual fundamental modes—polynomials such as, for example, the Zernike polynomial—, which is referred to as modal analysis. The order of the fundamental mode is here linked directly to the number of necessary sensing points—individual measurements. If low-frequency fundamental modes are to be analyzed exclusively spatially in a wavefront measurement, a complete sensing of the entire wavefront is not absolutely necessary. The reconstruction based on non-overlapping, spatially separate partial measurements is thus feasible. This can clearly reduce the time necessary for a measurement in scanning processes, since no continuous partial measurements are necessary. In fact, when a wavefront sensor array is used, for example, according to FIGS. 9 and 10, only a single measurement by a simultaneous recording of all the participating wavefront sensors is necessary in order to reconstruct the entire wavefront with sufficient precision.

The intensity distribution within the cross section of the wavefront to be measured can clearly vary, depending on the light source used, for example, laser, wherein the maximum intensity can occur, for example, in the beam center, and the minimum intensity can occur in the marginal area. If image sensors are used as detectors, different intensity profiles can be compared by superposition of images recorded with different exposure times or by using image sensors based on multislope integration methods—pixels with variable exposure time.

With regard to additional advantageous designs of the method according to the invention and of the apparatus according to the invention, in order to avoid repetitions, reference is made to the general part of the description as well as to the appended claims.

Finally, it is explicitly pointed out that the above-described embodiment examples of the teaching according to the invention are used only to explain the claimed teaching without limiting said teaching to the embodiment examples.

1. A method for measuring a curved wavefront using at least one wavefront sensor, wherein a plurality of measurements are carried out at different positions along the wavefront using at least one wavefront sensor in order to determine a local gradient of the wavefront at the different positions,
characterized in that the plurality of measurements are carried out in each case with a substantially tangential alignment of a light entrance plane of the wavefront sensor(s) with the curved wavefront.

2. The method according to claim 1, characterized in that the wavefront sensor is a Shack-Hartmann sensor.

3. The method according to claim 1 or 2, characterized in that the Shack-Hartmann sensor or wavefront sensor is aligned at the different positions in such a manner that a function f(σ₁, σ₂, . . . , σ_{N}), which is dependent on at least one displacement σₖ of a focal point from a reference point of a microlens of the Shack-Hartmann sensor or wavefront sensor, is minimized, wherein the displacement σₖ of the associated focal point corresponds to an image of a local inclination in the wavefront by means of the respective microlens.

4. The method according to claim 3, characterized in that the function f(σ₁, σ₂, . . . , σ_{N}) represents the weighted average of all the displacements σₖ or the weighted average of the squares of all the displacements σₖ.

5. The method according to claim 3 or 4, characterized in that the alignment of one or more wavefront sensors is carried out in such a manner that the displacement(s) σₖ is/are as small as possible or below a predeterminable threshold value.

6. The method according to any one of claims 1 to 5, characterized in that the alignment of one or more wavefront sensors is carried out in each case before a measurement and/or between two or more measurements.

7. The method according to any one of claims 1 to 6, characterized in that the alignment of one or more wavefront sensors is carried out continuously during a movement of one or more wavefront sensors.

8. The method according to any one of claims 1 to 7, characterized in that the wavefront sensor(s) is/are moved along one or more substantially circular trajectories in order to reach the different positions.

9. The method according to any one of claims 1 to 8, characterized in that the measurements are carried out with at least partial overlap along the wavefront.

10. The method according to any one of claims 1 to 9, characterized in that the wavefront sensor(s) is/are pivotable around one axis or two different axes, wherein, in the case of two axes, the axes are oriented preferably at a right angle with respect to one another and/or preferably intersect.

11. The method according to claim 1, characterized in that the wavefront sensor(s) is/are aligned via a controller of a control circuit, in such a manner that a focal point of the wavefront, generated by means of a lens of a wavefront sensor, lies on an optical axis of the lens, wherein the local gradient of the wavefront is preferably derived from the control signals generated for the alignment of the wavefront sensor(s).

12. The method according to any one of claims 1 to 10, characterized in that an optical system generating the wavefront is rotated around an optical axis for the relative positioning of the wavefront with respect to the wavefront sensor(s).

13. The method according to any one of claims 1 to 10, characterized in that one or more wavefront sensors suspended at a suspension point are set in oscillating motion around the suspension point in order to reach the different positions.

14. The method according to any one of claims 1 to 10, characterized in that a plurality of wavefront sensors are arranged on a carrier, wherein preferably the wavefront sensors can be tilted relative to the carrier around at least one axis and preferably shifted relative to the carrier.

15. The method according to any one of claims 1 to 10, characterized in that an end of an optical waveguide sweeps the wavefront at least in sections, and light received at the different positions is transmitted by means of the optical waveguide to the light entrance plane of the wavefront sensor(s).

16. The method according to claim 15, characterized in that the optical waveguide is set in scanning motion, preferably along a circular track, by means of a movement device.

17. The method according to any one of claims 1 to 10, characterized in that the wavefront is reflected via at least one mirror onto the wavefront sensor(s), wherein the mirror is pivoted around one axis or two axes for the measurement at the different positions.

18. An apparatus for measuring a curved wavefront using at least one wavefront sensor, in particular for carrying out the method according to any one of claims 1 to 17, wherein a plurality of measurements are carried out at different positions along the wavefront using at least one wavefront sensor for the determination of a local gradient of the wavefront at the different positions,
characterized in that, for carrying out the plurality of measurements, the wavefront sensor(s) can be positioned with substantially tangential alignment of a light entrance plane of the wavefront sensor(s) with the curved wavefront.
